(19) United States
(12) Patent Application Publication
(10) Pub. No.: US 2011/0292251 A1
(43) Pub. Date: Dec. 1, 2011

(54) CAMERA AND METHOD OF DISPLAYING IMAGE THEREON

(75) Inventors: Toshikazu Takayanagi, Suwon-si (KR); Tae-gil Kang, Suwon-si (KR)

(73) Assignee: Samsung Electronics Co., Ltd., Suwon-si (KR)

(21) Appl. No.: 13/150,412

(22) Filed: Jun. 1, 2011

(30) Foreign Application Priority Data
Jun. 1, 2010 (KR) 10-2010-0051903

(51) Int. Cl. H04N 5/262; G03B 15/02; G03B 15/06

(52) U.S. Cl. 348/239; 396/175; 362/11; 348/E05.051

(57) ABSTRACT

A camera includes light sources that illuminate a subject, a lens unit that receives image information of the subject, a controller that determines a shadow representation of the subject according to information regarding the light sources, and a display unit that displays the determined shadow representation. A method of displaying an image on a camera includes determining a shadow representation of a subject according to information regarding light sources that illuminate the subject, and displaying the determined shadow representation.

### CROSS-REFERENCE TO RELATED PATENT APPLICATION

This application claims the priority benefit of Korean Patent Application No. 10-2010-0051903, filed on Jun. 1, 2010, in the Korean Intellectual Property Office, the entire disclosure of which is incorporated herein by reference.

### BACKGROUND

1. Field of the Invention

Embodiments generally relate to a camera and a method of displaying an image thereon, and more particularly, to a camera including a plurality of light sources and a method of displaying an image input to the camera and controlling the plurality of light sources.

2. Description of the Related Art

A user may change a shade around a subject by disposing a single light source in front of the camera to capture the subject. In this case, since the shade of the subject is determined by the single light source, it is difficult to generate various types of shades.

A Xenon lamp may be used as the single light source. The Xenon lamp is a lighting device that emits instantaneous light of a short wavelength. The Xenon lamp emits light by putting a pair of electrodes in a quartz tube that includes Xenon gas and discharging electricity between the pair of electrodes. The Xenon lamp is mainly used to capture an image or secure a range of view at night.

### SUMMARY

According to an embodiment, there is provided a camera. The camera includes light sources that illuminate a subject, a lens unit that receives image information of the subject, a controller that determines a shadow representation of the subject according to information regarding the light sources, and a display unit that displays the determined shadow representation.

The controller may control a light-emitting state of the light sources by using the shadow representation displayed on the display unit.

The controller may add or modify a shadow to or of at least one selected from the group consisting of the subject displayed on the display unit, a portion of the subject displayed on the display unit, and an object representing the subject displayed on the display unit.

The camera may further include a storage unit that stores at least one object associated with shadow representations, wherein the controller determines the at least one object as the shadow representation of the subject based on the information regarding the light sources.

The camera may further include a driver that changes a direction of at least one of the light sources, wherein the controller determines the shadow representation of the subject based on the change.

The camera may further include an input unit that receives a user's command for controlling at least one of the light sources, wherein the controller determines the shadow representation of the subject according to the user's command, and the information regarding the light sources includes the user's command.

The display unit may display a menu for receiving the user's command for each of the light sources.

The menu may include submenus, each of the submenus corresponding to a respective one of the light sources, and the submenus are displayed on the display unit in positions corresponding to the respective one of the light sources.

The information regarding the light sources may include information regarding a light-emitting state of at least one of the light sources, and the controller acquires the information regarding the light-emitting state of the at least one of the light sources and determines the shadow representation of the subject by using the information regarding the light-emitting state.

The information regarding the light-emitting state of the at least one of the light sources may include information regarding at least one selected from the group consisting of a light-emitting amount, a light-emitting time, a light-emitting color, and a light emission of the at least one of the light sources.

The camera may further include a sensor unit that acquires information regarding an environment around the subject, wherein the controller determines the shadow representation of the subject according to the information regarding the environment, and the information regarding the light sources includes the information regarding the environment.

The controller may determine the shadow representation of the subject by analyzing image information of the subject, and the information regarding the light sources includes information obtained by analyzing the image information.

According to another embodiment, there is provided a light-emitting apparatus. The light-emitting apparatus includes light sources, a circuit substrate equipped with the light sources, and a holder on one surface of the circuit substrate and fixes the circuit substrate to the light-emitting apparatus.

The light-emitting apparatus may further include a light-concentrating lens on the holder.

The holder may include reflecting mirrors, and each of the reflecting mirrors is on one of the light sources.

According to another embodiment, there is provided a method of displaying an image on a camera. The method includes determining a shadow representation of a subject according to information regarding light sources that illuminate the subject; and displaying the determined shadow representation.

The information regarding the light sources may include information regarding a light-emitting state of at least one of the light sources, and the determining of the shadow representation may include acquiring the information regarding the light-emitting state of the at least one of the light sources, and determining the shadow representation of the subject by using the information regarding the light-emitting state.

The method may further include receiving a user's command for controlling at least one of the light sources, wherein the information regarding the light sources includes the user's command.

The method may further include displaying a menu for receiving the user's command for each of the light sources.

According to another embodiment, there is provided a method of displaying an image on a camera. The method includes acquiring information regarding a light-emitting state of at least one of a multitude of light sources, determining a shadow representation of a subject by using the information regarding the light-emitting state, and displaying the determined shadow representation.

According to another embodiment, there is provided a computer-readable recording medium storing a computer-readable program for executing the method of displaying an image on a camera.

### BRIEF DESCRIPTION OF THE DRAWINGS

The above and other features and advantages will become more apparent by describing in detail exemplary embodiments with reference to the attached drawings in which:

FIG. 1 is a block diagram of a camera according to an exemplary embodiment;

FIG. 2 shows a camera including a plurality of light sources, according to an exemplary embodiment;

FIG. 3 shows an input unit according to an exemplary embodiment;

FIGS. 4A-4J show shadow representations and light-emitting states of a plurality of light sources, according to an exemplary embodiment;

FIG. 5 shows an input unit according to another exemplary embodiment;

FIG. 6 shows a menu for controlling a plurality of light sources, according to an exemplary embodiment;

FIG. 7 shows operations of a driver, according to an exemplary embodiment;

FIG. 8 is an exploded view of a light-emitting apparatus according to an exemplary embodiment;

FIG. 9 is a flowchart of a method of controlling light emitting of the camera, according to an exemplary embodiment; and

FIG. 10 is a flowchart of a method of displaying an image on the camera, according to an exemplary embodiment.

### DETAILED DESCRIPTION

Embodiments will now be described more fully with reference to the accompanying drawings, in which exemplary embodiments are shown. However, the invention is not limited to the embodiments shown. Like reference numbers are used to refer to like elements throughout the drawings.

A camera according to an exemplary embodiment may provide a menu that can control a plurality of light sources and may acquire information for controlling the plurality of light sources based on information obtained by a user operating the menu. The camera may then control the plurality of light sources by using the acquired information.

When the user controls the plurality of light sources, an object representing a subject may be provided on a display unit. The user may determine a shadow representation of the object by operating the menu associated with the plurality of light sources. Thereafter, the user may control the plurality of light sources to represent a shadow of the subject as the shadow representation of the object displayed on the display unit by pressing a button for capturing the subject.

The shadow representation can be a representation of a shadow and can include, for example, representation of brightness, saturation, or color of the subject or the object. The representation of the shadow may be represented by a dot, a line, a side, or a solid.

When the plurality of light sources are used, the shadow of the subject may be freely changed while minimizing the use of an external lighting device or a board reflector by individually or simultaneously controlling at least one selected from the group consisting of a light-emitting amount, a light-emitting time, a light-emitting color, and a light emission (on/off) of the plurality of light sources.

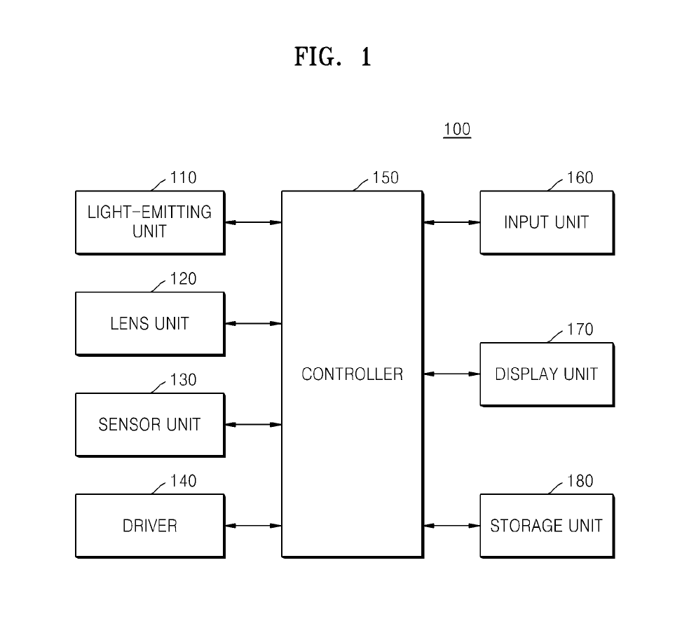

FIG. 1 is a block diagram of a camera 100 according to an exemplary embodiment. Referring to FIG. 1, the camera 100 may include a light-emitting unit 110, a lens unit 120, a sensor unit 130, a driver 140, a controller 150, an input unit 160, a display unit 170, and a storage unit 180.

The camera 100 can be a device that can capture an image, e.g., a device that can receive or store a still image or a video image in a 2D or 3D format. The camera 100 may include any device that can capture an image. Examples of the camera 100 can be a typical camera that can capture, store, and display an image; a camcorder that can capture a video image; a cellular phone; a smart phone; a Personal Digital Assistant (PDA); and a net book having a function of capturing an image.

The camera 100 may include the lens unit 120, the display unit 170, the controller 150, and the light-emitting unit 110. The lens unit 120 may receive image information of a subject. The image information of the subject may be an optical signal associated with the subject, and the lens unit 120 may acquire the image information of the subject from an image of the subject obtained by refracting light reflected from the subject.

The display unit 170 may represent a shadow of the subject displayed on the display unit 170, based on information regarding a plurality of light sources. For example, the display unit 170 may include a display device, such as a Liquid Crystal Display (LCD).

The information regarding the plurality of light sources, which can be used for the display unit 170 to represent a shadow, may include information regarding a light-emitting state of a light source, a user's command, information regarding an environment around the subject, and information obtained by analyzing an image signal of the subject. A shadow representation of the subject displayed on the display unit 170 may include adding or modifying a shadow to or of at least one selected from the group consisting of the subject displayed on the display unit 170, a portion of the subject displayed on the display unit 170, and an object representing the subject displayed on the display unit 170.

The controller 150 may determine the shadow representation displayed on the display unit 170 based on the information regarding the plurality of light sources. For example, the controller 150 may include an Arithmetic Logic Unit (ALU) that can perform calculation and a register that can temporarily store data and a command.

The controller 150 may receive information that can control the plurality of light sources from a user, may determine the shadow representation of the subject according to the received information, and may display the determined shadow representation on the display unit 170. The controller 150 may add or modify a shadow to or of at least one selected from the group consisting of the subject displayed on the display unit 170, a portion of the subject displayed on the display unit 170, and an object representing the subject displayed on the display unit 170. When a signal for capturing is received from the user, the controller 150 may control at least one of the plurality of light sources to capture the subject as the shadow representation of the subject.

The controller 150 may acquire information regarding a light-emitting state of at least one of the plurality of light sources from the light-emitting unit 110. The information regarding the light-emitting state may be information regarding a state in which at least one of the plurality of light sources emits. The information regarding the light-emitting state can include, for example, at least one selected from the group consisting of a light-emitting amount, a light-emitting time, a light-emitting color, and a light emission (on/off) of at least one of the plurality of light sources. The controller 150 may determine the shadow representation of the subject by using the information regarding the light-emitting state of the at least one of the plurality of light sources or control the light-emitting state of the at least one of the plurality of light sources based on the information for controlling the plurality of light sources.

The controller 150 may determine the shadow representation of the subject by acquiring the image information of the subject from the lens unit 120 and analyzing the image information. For example, the controller 150 may acquire data of a Red (R), Green (G), and Blue (B) format by converting an optical signal associated with the subject to an electrical signal based on the light intensity of each wavelength. The controller 150 may determine a light source to be emitted among the plurality of light sources by transforming RGB data to data of a YUV format by an image transforming means and by using a luminance component detected from the YUV data. The light source determined by the controller 150 may emit light with predetermined intensity of light or provide information regarding the light source to be emitted to the user through the display unit 170.

The light-emitting unit 110 may include the plurality of light sources to illuminate the subject and may emit light toward the subject by using the plurality of light sources. For example, at least one of the plurality of light sources may include a Light-Emitting Diode (LED), a Xenon lamp, a Halogen lamp, or a Sodium lamp.

The plurality of light sources may be disposed around the lens unit 120 in a ring or symmetrical shape to make an axis of the plurality of light sources and an axis of a lens the same so that the plurality of light sources are evenly distributed in a direction desired by the user based on the subject and emitted light.

At least one of the plurality of light sources may be disposed in one side of the camera 100 or at a considerable distance from the lens unit 120 to enlarge a light-emitting angle of the light source based on the subject. For example, two or more of the plurality of light sources may be disposed on different sides of the camera 100 to enlarge a light-emitting angle of the light sources. When a cellular phone is used as an image photographing device, at least one of the plurality of light sources may be disposed on one side of the cellular phone at a considerable distance from the lens unit 120 in order to be controlled according to an image capturing function executed by the cellular phone.

At least one of the plurality of light sources may perform a function of an auxiliary light source for auto focusing, a catch light for figure capturing, or an auxiliary lighting for video capturing.

When a plurality of LEDs are used as a light-emitting source instead of a single Xenon lamp, since a volume of the LEDs can be smaller and the number of parts for a circuit configuration can be smaller, the camera 100 may be miniaturized.

In addition, while a lot of time can be required to charge a condenser for reemitting light and it can be difficult to emit light for a long time when the Xenon lamp is used, it can be possible to quickly and continuously emit light when the plurality of LEDs are used. In addition, the plurality of LEDs may have a lifespan around more than twice that of the Xenon lamp, may have a smooth light distribution so that a subject is naturally captured, and may emit light of various colors.

When the plurality of LEDs are used instead of the single Xenon lamp, since selective light emitting can be possible, unnecessary power consumption may be reduced. In addition, for the plurality of LEDs, at least one selected from the group consisting of a light-emitting amount, a light-emitting time, a light-emitting color, and a light emission (on/off) of the plurality of light sources may be controlled individually or simultaneously. In addition, when the user uses the Xenon lamp to capture a subject at night, the subject to be captured can be whitened or appear white due to light being too bright. However, when the plurality of light sources are used, the subject may be clearly captured even at night by selectively emitting only the least light that can secure a range of view.

The light-emitting unit 110 may operate by being assembled with the camera 100 or may be detachably attached to the camera 100 by the user.

The camera 100 may further include the input unit 160. The input unit 160 may receive a user's command to control at least one of the plurality of light sources. For example, the input unit 160 may include a dial, a button, or a touch screen that can receive the user's command. The input unit 160 may deliver the user's command received from the dial, the button, or the touch screen to the controller 150. Upon receiving the user's command from the input unit 160, the controller 150 may determine the shadow representation of the subject displayed on the display unit 170 according to the user's command. The controller 150 may also control the plurality of light sources of the light-emitting unit 110 according to the user's command received from the input unit 160.

When the input unit 160 includes one or more buttons capable of operating as a half-shutter button and a full-shutter button, the input unit 160 may transmit a user's command from pressing the half-shutter button to the controller 150. The controller 150 may display a shadow representation of a subject determined based on the information regarding the plurality of light sources on the display unit 170.

When the controller 150 receives a user's command from pressing the full-shutter button from the input unit 160, the controller 150 may control a light-emitting state of the plurality of light sources to capture the subject as the shadow representation of the subject.

The camera 100 may further include the sensor unit 130. The sensor unit 130 may acquire information regarding an environment around a subject. For example, the sensor unit 130 may sense a luminance change around the subject by using a light intensity sensing sensor and may convert the sensing signal to an electrical signal.

The sensor unit 130 may deliver the acquired information regarding the environment around the subject to the controller 150, and the controller 150 may determine a shadow representation of the subject displayed on the display unit 170 or control a light-emitting state of the plurality of light sources by using the information regarding the environment acquired by the sensor unit 130. In addition, the controller 150 may control the plurality of light sources and may adjust at least one selected from the group consisting of sensitivity of a film, an iris, and a shutter speed for an Auto Exposure (AE) function of the camera 100 by using the information acquired by the sensor unit 130. In addition, the controller 150 may control the plurality of light sources to emit the least light based on the surrounding brightness by using the information acquired by the sensor unit 130 when capturing is performed at night.

The sensor unit 130 may usually operate by being directly connected to the camera 100. However, the sensor unit 130 may be detachably attached to the camera 100 and may deliver information regarding the environment around the subject to the controller 150 through wireless communication.

The camera 100 may further include the storage unit 180. The storage unit 180 may store at least one object associated with a plurality of shadow representations. For example, the storage unit 180 may include a module capable of inputting and outputting information, such as a Compact Flash (CF) card, a Secure Digital (SD) card, a Smart Media (SM) card, a Multimedia Card (MMC), or a memory stick. When an object for a shadow representation of a subject is requested by the controller 150, the storage unit 180 may deliver at least one object to the controller 150. In this case, the controller 150 may determine the shadow representation of the subject by determining at least one of a plurality of objects received based on the information regarding the plurality of light sources as the shadow representation of the subject or adding or modifying a shadow representation to or of at least one of the plurality of objects.

The camera 100 may further include the driver 140. The driver 140 may change a direction of at least one of the plurality of light sources. For example, the driver 140 may include an actuator or a motor. The actuator can be a device operating in response to a signal processed by a signal processor and may include, for example, a multi-turn actuator, a linear actuator, an ultrasonic actuator, a Direct Current (DC) actuator, or an Alternate Current (AC) actuator. The actuator may perform an operation, such as tilting, shifting, or rotating in the up, down, left, or right direction. However, embodiments are not limited to these directions. A bearing for a smooth operation may be further included between the actuator and the lens unit 120.

When the driver 140 includes a motor, at least one motor may be included. The light-emitting unit 110 may operate in the up, down, left, or right direction based on the lens unit 120 according to an operation of the motor to adjust a light source emitting angle. However, embodiments are not limited to these directions.

The driver 140 may be physically separated from the lens unit 120 to secure a physical distance for operating based on the lens unit 120. The physical gap may be packed with rubber so as to prevent introduction of a foreign substance from the outside.

An operating direction of the driver 140 may be changed based on the information regarding the plurality of light sources. The controller 150 may determine a shadow representation of a subject based on the change of the driver 140. In addition, the controller 150 may change the operating of the driver 140 as a shadow representation of the subject displayed on the display unit 170.

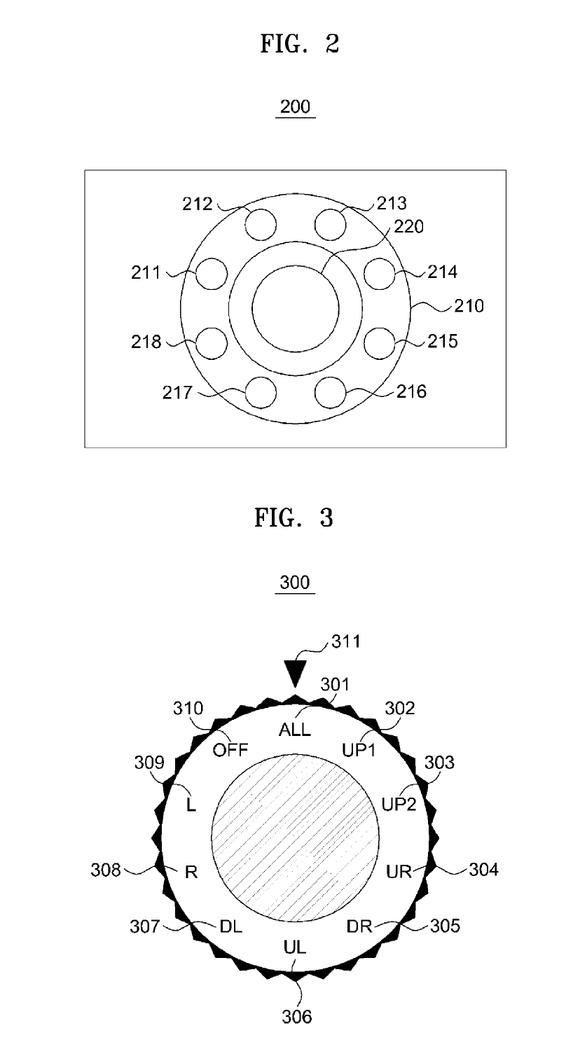

FIG. 2 shows a camera 200 including a plurality of light sources, according to an exemplary embodiment. The camera 200 may include a lens unit 220 and a light-emitting unit 210. The light-emitting unit 210 may include the plurality of light sources, and the plurality of light sources may include a first light source 211, a second light source 212, a third light source 213, a fourth light source 214, a fifth light source 215, a sixth light source 216, a seventh light source 217, and an eighth light source 218 as shown in FIG. 2.

The controller 150 shown in FIG. 1 may acquire information regarding a light-emitting state of the plurality of light sources from the light-emitting unit 210 shown in FIG. 2 and may determine a shadow representation of a subject by using the acquired information. In addition, the controller 150 may control the plurality of light sources 211 to 218 of the light-emitting unit 210 to capture the subject as a shadow representation of the subject displayed on the display unit 170.

The camera 200 may include the lens unit 220 and the light-emitting unit 210, and the light-emitting unit 210 can include at least one selected from the group consisting of a red LED, a green LED, a blue LED, and a white LED.

The lens unit 220 can be for receiving image information of a subject and may acquire information regarding the subject by collecting light reflected from the subject. An LED can be a compound optical semiconductor device that can convert electrical energy or an electrical signal to optical energy or an optical signal by an operation of a semiconductor. The compound optical semiconductor device may include a red LED, a green LED, a blue LED, and a white LED.

A single LED may emit different colors according to the magnitude of a voltage or current. A plurality of light sources may be assembled around the lens unit 220, and the plurality of light sources may include at least one selected from the group consisting of a red LED, a green LED, a blue LED, and a white LED, and a single light source may emit a plurality of colors.

The camera 200 may further include the display unit 170. The display unit 170 can be for representing a shadow of a subject, which is displayed on the display unit 170, based on information regarding the plurality of light sources 211 to 218 included in the light-emitting unit 210. The display unit 170 may display the shadow representation of the subject by using at least one color selected from the group consisting of red, green, blue, and white. In addition, the display unit 170 may provide a menu for each of the plurality of light sources 211 to 218 to control a light-emitting state of the plurality of light sources 211 to 218. A user may select a light-emitting color of at least one of the plurality of light sources 211 to 218 from the display unit 170, and the display unit 170 may change a light-emitting state of at least one of the plurality of light sources 211 to 218 or display a shadow representation of a subject by using the selected light-emitting color.

FIG. 3 shows an input unit 300 according to an exemplary embodiment. Referring to FIG. 3, the input unit 300 of a dial method may receive a user's command for controlling at least one of a plurality of light sources. For example, the input unit 300 of a dial method may include an ALL mode 301, a UP1 mode 302, a UP2 mode 303, a UR mode 304, a DR mode 305, a UL mode 306, a DL mode 307, an R mode 308, an L mode 309, and an OFF mode 310 to control the plurality of light sources. A user may select any one of the above-described modes by using a mode selection button 311. The controller 150, when it has received a user's command for selecting one mode, may determine a shadow representation of a subject displayed on the display unit 170 according to the user's command. In addition, the controller 150 may control the plurality of light sources according to the user's command for selecting one mode.

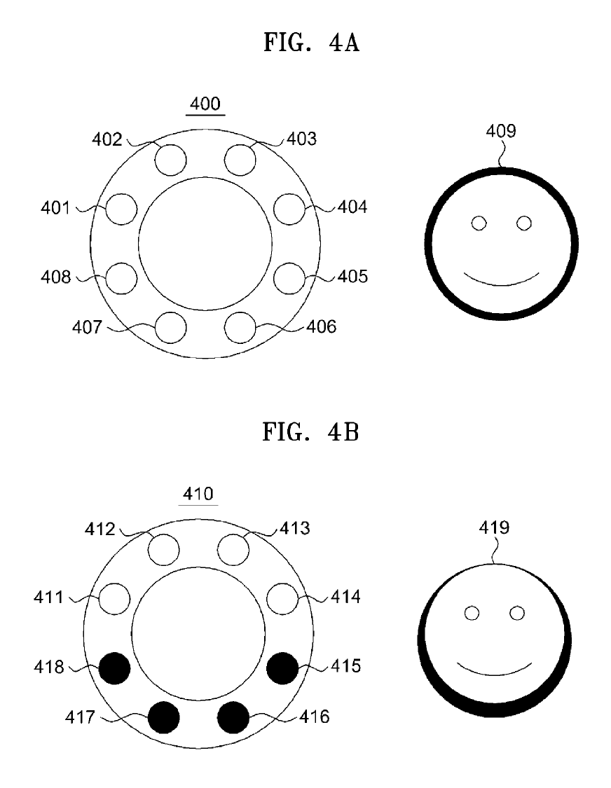

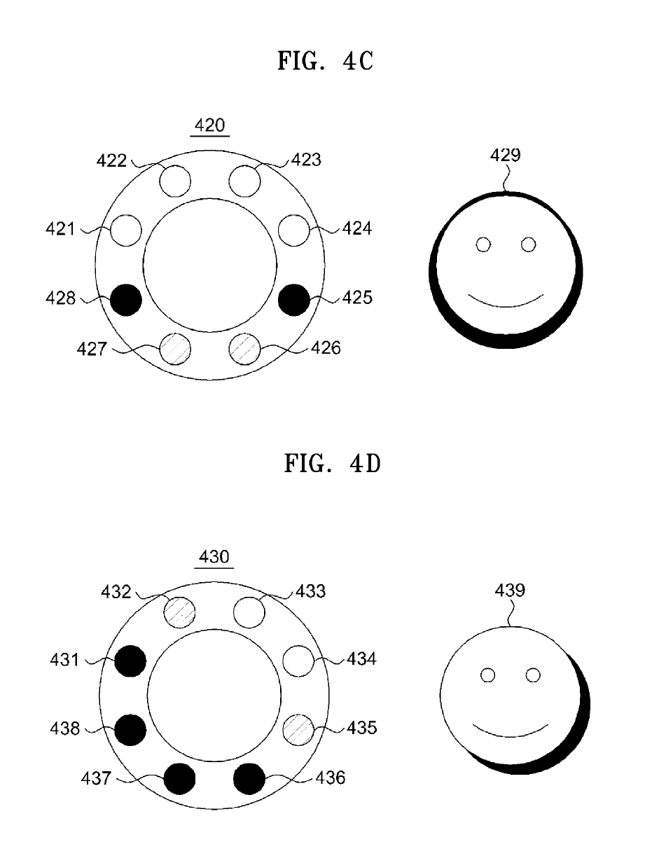

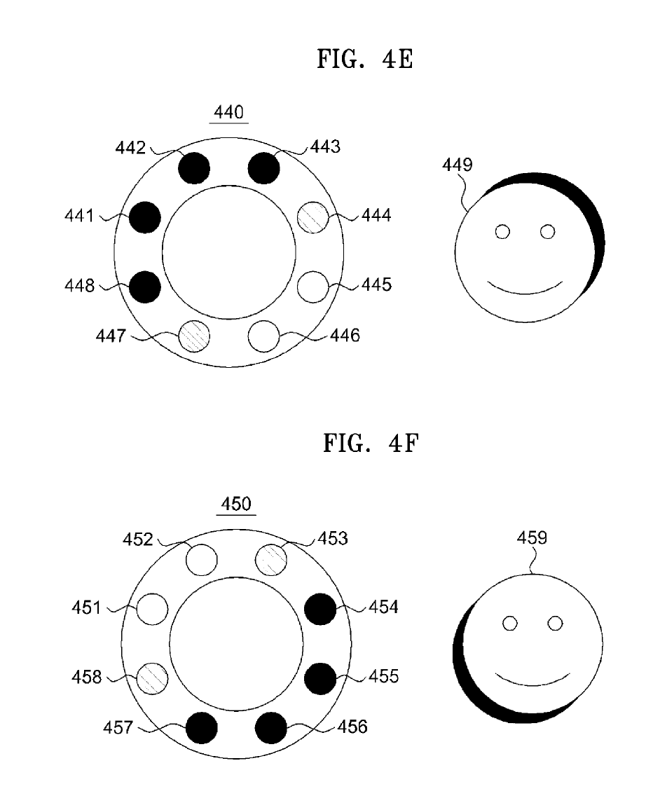

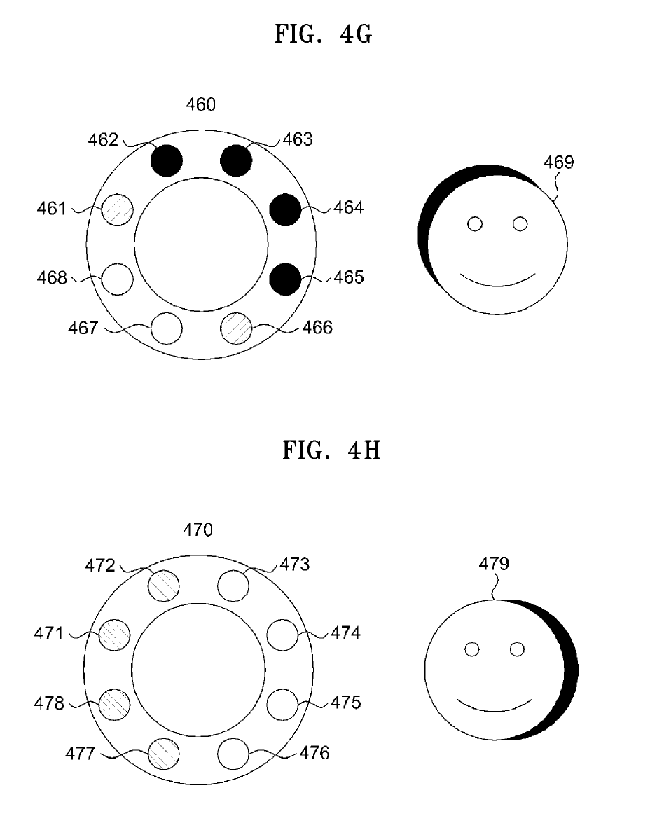

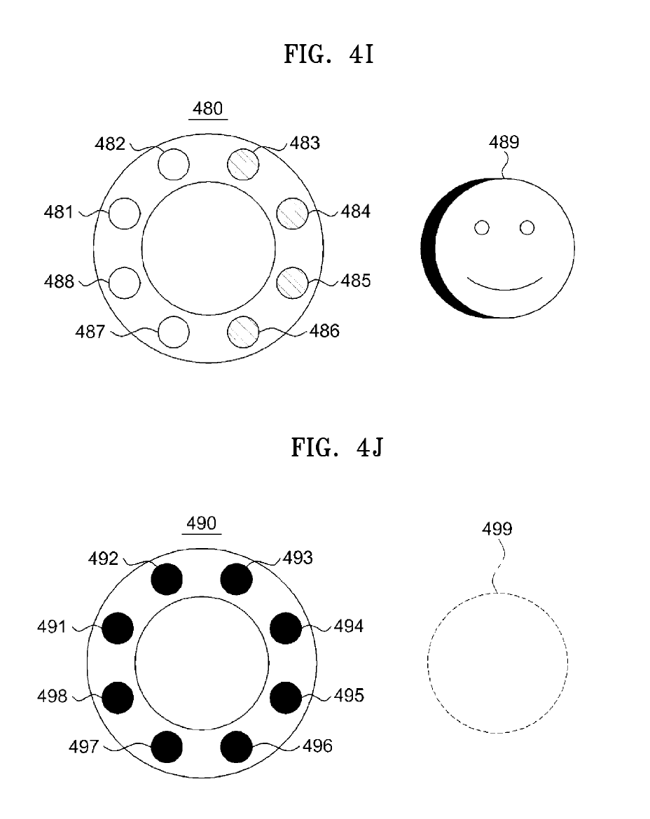

FIGS. 4A to 4J show shadow representations and light-emitting states of a plurality of light sources, according to an exemplary embodiment. Each of FIGS. 4A to 4J shows a shadow representation of an object according to a corresponding mode, which is represented on the display unit 170, and a light-emitting state of the plurality of light sources of the light-emitting unit 110, which corresponds to the shadow representation, when one mode is selected by the input unit 300 of a dial method. For example, a shadow representation method of an object according to a corresponding mode is as follows.

1. ALL mode 400: can make the entire object 409 evenly bright or attach a shadow around the object 409.

2. UP1 mode 410: can make an upper part of an object 419 bright or attach a shadow to a lower part of the object 419.

3. UP2 mode 420: can make an upper part of an object 429 bright or attach a shadow having a small thickness to a lower part of the object 429.

4. UR mode 430: can make an upper-right part of an object 439 bright or attach a shadow to a lower-right part of the object 439.

5. DR mode 440: can make a lower-right part of an object 449 bright or attach a shadow to an upper-right part of the object 449.

6. UL mode 450: can make an upper-left part of an object 459 bright or attach a shadow to a lower-left part of the object 459.

7. DL mode 460: can make a lower-left part of an object 469 bright or attach a shadow to an upper-left part of the object 469.

8. R mode 470: can make a right part of an object 479 bright or attach a shadow to the right part of the object 479.

9. L mode 480: can make a left part of an object 489 bright or attach a shadow to the left part of the object 489.

10. OFF mode 490: can display no object.

A light-emitting state of the plurality of light sources of the light-emitting unit 110, which corresponds to a shadow representation of each of the modes described above, is described below. In the following description, a reference light-emitting amount can indicate an amount of predetermined emitted light previously set by the camera 100 or 200 or the user.

1. ALL mode 400: can cause all of a first light source 401, a second light source 402, a third light source 403, a fourth light source 404, a fifth light source 405, a sixth light source 406, a seventh light source 407, and an eighth light source 408 to each emit light.

2. UP1 mode 410: can cause a first light source 411, a second light source 412, a third light source 413, and a fourth light source 414 to each emit light with the reference light-emitting amount and prevent a fifth light source 415, a sixth light source 416, a seventh light source 417, and an eighth light source 418 from emitting light.

3. UP2 mode 420: can cause a first light source 421, a second light source 422, a third light source 423, and a fourth light source 424 to each emit light with the reference light-emitting amount, can cause a sixth light source 426 and a seventh light source 427 to each emit light with 30% of the reference light-emitting amount, and can prevent a fifth light source 425 and an eighth light source 428 from emitting light.

4. UR mode 430: can cause a third light source 433 and a fourth light source 434 to each emit light with the reference light-emitting amount, can cause a second light source 432 and a fifth light source 435 to each emit light with 30% of the reference light-emitting amount, and can prevent a first light source 431, a sixth light source 436, a seventh light source 437, and an eighth light source 438 from emitting light.

5. DR mode 440: can cause a fifth light source 445 and a sixth light source 446 to each emit light with the reference light-emitting amount, can cause a fourth light source 444 and a seventh light source 447 to each emit light with 30% of the reference light-emitting amount, and can prevent a first light source 441, a second light source 442, a third light source 443, and an eighth light source 448 from emitting light.

6. UL mode 450: can cause a first light source 451 and a second light source 452 to each emit light with the reference light-emitting amount, can cause a third light source 453 and an eighth light source 458 to each emit light with 30% of the reference light-emitting amount, and can prevent a fourth light source 454, a fifth light source 455, a sixth light source 456, and a seventh light source 457 from emitting light.

7. DL mode 460: can cause a seventh light source 467 and an eighth light source 468 to each emit light with the reference light-emitting amount, can cause a first light source 461 and a sixth light source 466 to each emit light with 30% of the reference light-emitting amount, and can prevent a second light source 462, a third light source 463, a fourth light source 464, and a fifth light source 465 from emitting light.

8. R mode 470: can cause a third light source 473, a fourth light source 474, a fifth light source 475, and a sixth light source 476 to each emit light with the reference light-emitting amount and can cause a first light source 471, a second light source 472, a seventh light source 477, and an eighth light source 478 to each emit light with 30% of the reference light-emitting amount.

9. L mode 480: can cause a first light source 481, a second light source 482, a seventh light source 487, and an eighth light source 488 to each emit light with the reference light-emitting amount and can cause a third light source 483, a fourth light source 484, a fifth light source 485, and a sixth light source 486 to each emit light with 30% of the reference light-emitting amount.

10. OFF mode 490: none of the light sources 491, 492, 493, 494, 495, 496, 497, and 498 can emit light.

As shown in FIGS. 4A to 4J, to represent shadow representations of an object and light-emitting states of a plurality of light sources according to an exemplary embodiment, the controller 150 may first determine a shadow representation of a subject, which is displayed on the display unit 170, according to a user's command for selecting one mode. Next, when a command for capturing the subject is received from the user, the controller 150 may adjust a light-emitting state of the plurality of light sources to represent a shadow of the subject in correspondence with the shadow representation of the subject displayed on the display unit 170.

When the user's command for selecting one mode is received, the controller 150 may represent a shadow of the subject on the display unit 170 and simultaneously control a light-emitting state of the plurality of light sources. Alternatively, the controller 150 may control a light-emitting state of the plurality of light sources and then provide a shadow representation corresponding to the light-emitting state of the plurality of light sources to the display unit 170.

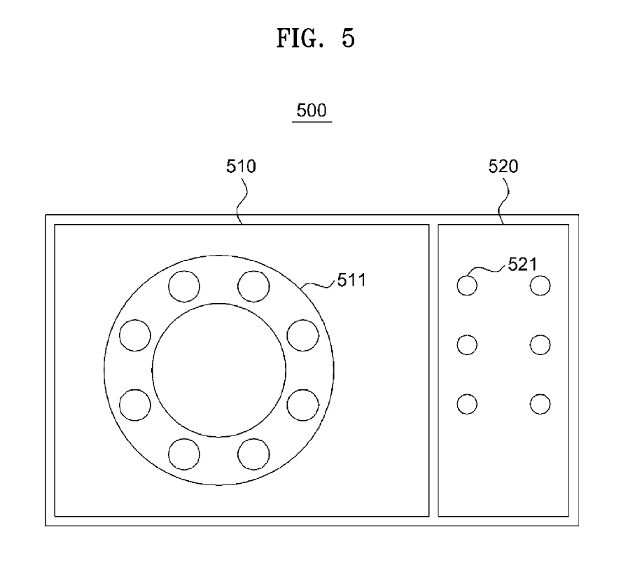

FIG. 5 shows an input unit according to another exemplary embodiment. A camera 500 shown in FIG. 5 may include a touch screen 510 and a button input unit 520. When a user touches a predetermined position of a screen included in the display unit 170, the touch screen 510 may perceive coordinates of the touched position and process a function corresponding to the coordinates. Examples of the touch screen 510 are a decompression touch screen, an electrostatic touch screen, and an optical touch screen.

The display unit 170 may provide a menu 511 of a plurality of light sources to receive a user's command. The menu 511 of the plurality of light sources may be displayed on the display unit 170 by reflecting positions of the plurality of light sources in the light-emitting unit 110. In addition, the menu 511 of the plurality of light sources may include a plurality of submenus.

When the user selects an area corresponding to at least one of the plurality of light sources from the menu 511 of the plurality of light sources, the touch screen 510 may provide information regarding the area selected by the user. The controller 150 may control a light-emitting state of the light source associated with the area selected by the user or add or modify a shadow of a subject by using the information received from the touch screen 510.

When the user selects one of a plurality of buttons 521, the button input unit 520 may transmit a signal corresponding to the selected button 521 to the controller 150 to process a function corresponding to the selected button 521. Examples of the plurality of buttons 521 are a push button, a jog button, and a button controllable with a remote control. The plurality of buttons 521 may be operated to sequentially or simultaneously control a light-emitting state of at least one of the plurality of light sources by a user's operation. The controller 150 may represent a shadow of a subject or control a light-emitting state of the plurality of light sources by using information received from the button input unit 520.

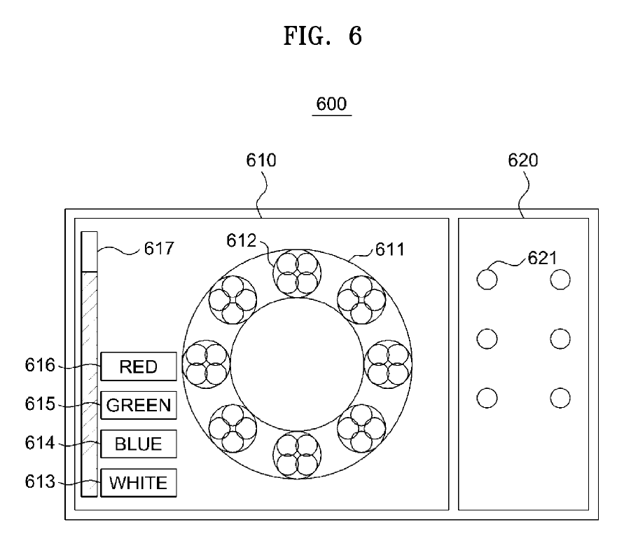

FIG. 6 shows an input unit according to another exemplary embodiment. A camera 600 shown in FIG. 6 may include a touch screen 610 and a button input unit 620. When a user touches a predetermined position of the screen 610 included in the display unit 170, the touch screen 610 may perceive coordinates of the touched position and process a function corresponding to the coordinates. The display unit 170 may provide a menu 611 of a plurality of light sources to receive a user's command. FIG. 6 shows the menu 611 that can control a plurality of light sources, according to an exemplary embodiment.

Referring to FIG. 6, the display unit 170 may provide the menu 611 of the plurality of light sources to represent a shadow of a subject or to control a light-emitting state of the plurality of light sources. The menu 611 of the plurality of light sources may include a plurality of submenus. The plurality of submenus can correspond to the plurality of light sources, respectively. Each of the plurality of submenus may include a menu that can control at least one selected from the group consisting of a light-emitting amount, a light-emitting time, a light-emitting color, and a light emission (on/off) of a corresponding light source. For example, a user may select a light source of which a light-emitting amount is needed to be adjusted by using a touch screen 610 or a button 621 of a button input unit 620, and the user can change a height of a bar by touching a bar type menu 617 or pushing a button 621 to adjust the light-emitting amount of the selected light source.

Likewise, the user may select a light source of which a light-emitting time is needed to be adjusted and change a height of a bar by touching the bar type menu 617 or pushing a button 621 to adjust the light-emitting time of the selected light source.

To adjust a light-emitting color of a light source, the user may select a light source of which a light-emitting color is needed to be adjusted by using the touch screen 610 or a button 621 of the button input unit 620. A single light source may include a plurality of light sources having different colors or may emit a plurality of colors according to a voltage or current applied thereto.

When a light source of which a light-emitting color is needed to be adjusted is selected, the user may select a single color by selecting one of a white menu 613, a blue menu 614, a green menu 615, and a red menu 616. Four small circles included in a single light source 612 can indicate red, blue, green, and white light sources, and a color selected by the user may be displayed on a corresponding small circle.

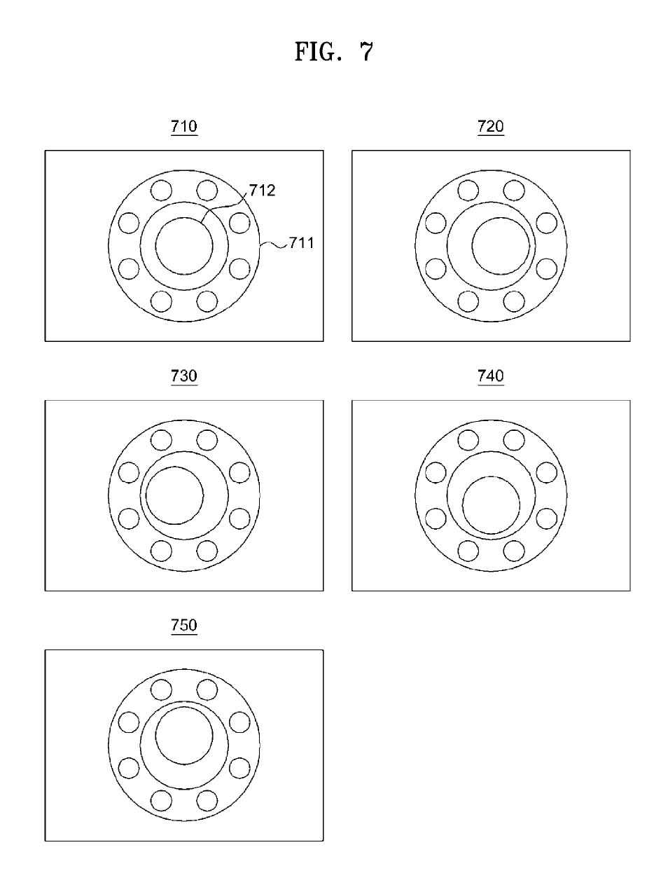

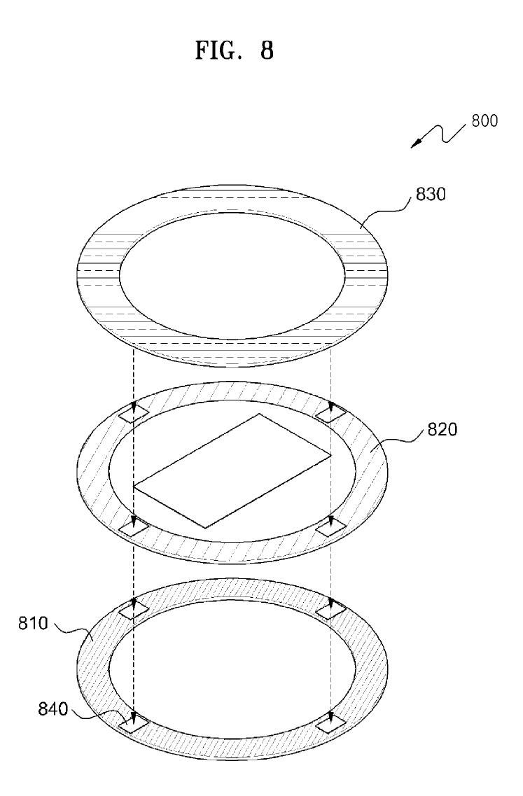

FIG. 7 shows operations of the driver 140, according to an exemplary embodiment. Referring to FIG. 7, the driver 140 may operate a light-emitting unit 711 including a plurality of light sources in a plurality of directions based on a lens unit 712 to change a direction of the plurality of light sources.

The driver 140 may operate the light-emitting unit 711 in the plurality of directions based on information regarding the plurality of light sources. FIG. 7 shows various operations of the light-emitting unit 711 operating in the plurality of directions based on the lens unit 712. According to the current embodiment, reference numeral 710 denotes a camera in which a direction of the light-emitting unit 711 is not changed; reference numeral 720 denotes the camera in which a direction of the light-emitting unit 711 is changed to the right; reference numeral 730 denotes the camera in which a direction of the light-emitting unit 711 is changed to the left; reference numeral 740 denotes the camera in which a direction of the light-emitting unit 711 is changed upwards; and reference numeral 750 denotes the camera in which a direction of the light-emitting unit 711 is changed downwards.

The driver 140 may compensate for a shadow biased to one side of a subject or for a counterlight due to an external light, such as sunlight or a fluorescent lamp. That is, the shadow or the counterlight on the subject may be reduced by emitting light toward a portion of the subject with insufficient light through an operation of the driver 140.

FIG. 8 is an exploded view of a light-emitting apparatus 800 according to an exemplary embodiment. Referring to FIG. 8, the light-emitting apparatus 800 may include a circuit substrate 810 and a holder 820.

The circuit substrate 810 can be a substrate that can be equipped with an electronic circuit with electronic devices. Examples of the circuit substrate 810 are a Printed Circuit Board (PCB), a Flexible Printed Circuit (FPC), and an elastic circuit board. The FPC is a flexible substrate and may be equipped with electronic devices and an electronic circuit. The elastic circuit board can be a foldable substrate and may be equipped with electronic devices and an electronic circuit.

The circuit substrate 810 may be equipped with a plurality of light sources 840 and an electronic circuit associated with the plurality of light sources 840 in various methods and configurations. For example, the plurality of light sources 840 may be disposed symmetrically and be equipped on the circuit substrate 810. At least one of the plurality of light sources 840 may be disposed in one side of a camera or separated at a considerable distance from the lens unit 120 to increase a light-emitting angle of the light source 840 based on a subject.

The plurality of light sources 840 equipped on the circuit substrate 810 can emit light and may include at least one LED, a Xenon lamp, a Halogen lamp, and a Sodium lamp. When an LED is used for at least one of the plurality of light sources 840, at least one of the plurality of light sources 840 may include a red LED, a green LED, a blue LED, and a white LED. In addition, at least one of the plurality of light sources 840 may be used to function as an auxiliary light source for auto focusing, a catch light for figure capturing, or an auxiliary lighting for video capturing.

The plurality of light sources 840 may be connected to the input unit 160 for receiving a user's command. For example, the input unit 160 may include a dial, one or more buttons, or a touch screen that can receive a user's command. The light-emitting apparatus 800 may receive a user's command through the input unit 160 and control a light-emitting amount, a light-emitting time, a light-emitting color, or a light emission (on/off) of at least one of the plurality of light sources 840 according to the user's command.

The holder 820 may be disposed on one surface of the circuit substrate 810 equipped with the plurality of light sources 840 to fix the circuit substrate 810 equipped with the plurality of light sources 840 to the light-emitting apparatus 800. When the holder 820 is assembled with the circuit substrate 810, the plurality of light sources 840 may protrude through holes in the edge of the holder 820, and a lens unit (not shown) may protrude through a hole in the center of the holder 820.

According to an exemplary embodiment, the holder 820 may further include a plurality of reflecting mirrors (not shown). The plurality of reflecting mirrors may be disposed on the plurality of light sources 840 to prevent dispersion of light of the plurality of light sources 840.

The light-emitting apparatus 800 may further include a light-concentrating lens 830. The light-concentrating lens 830 may be disposed on the holder 820 to concentrate light of the plurality of light sources 840 and may collect light, increase resolution of an image, or refract light. For example, the light-concentrating lens 830 may include a Fresnel lens. The Fresnel lens may concentrate light in a desired direction or to a desired place by adjusting a refractive index using a plurality of concentric holes in the surface thereof.

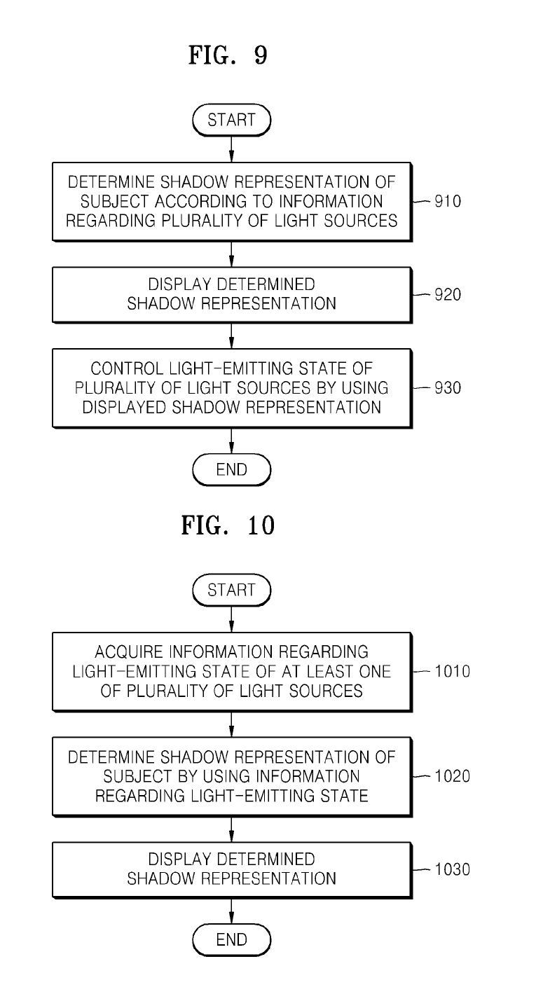

A method of displaying an image on the camera 100, according to an exemplary embodiment, is described as follows with reference to FIGS. 9 and 10. FIG. 9 is a flowchart of a method of controlling light emitting of the camera 100, according to an exemplary embodiment.

Referring to FIG. 9, in operation 910, the camera 100 can determine a shadow representation of a subject according to information regarding a plurality of light sources for illuminating the subject. In operation 910, the information regarding the plurality of light sources may include information regarding a light-emitting state of a light source, a user's command, information regarding an environment around the subject, and information obtained by analyzing an image signal of the subject.

The shadow representation can be a representation of a shadow, and the camera 100 may add or modify a shadow to or of at least one selected from the group consisting of the subject displayed on the display unit 170, a portion of the subject displayed on the display unit 170, and an object representing the subject displayed on the display unit 170.

The camera 100 may acquire information regarding a light-emitting state of at least one of the plurality of light sources to determine the shadow representation. The information regarding the light-emitting state can be information regarding a state where the plurality of light sources emit light and may include, for example, at least one selected from the group consisting of a light-emitting amount, a light-emitting time, a light-emitting color, and a light emission (on/off) of the at least one of the plurality of light sources. The camera 100 may determine the shadow representation of the subject by using the information regarding the light-emitting state of the at least one of the plurality of light sources or control a light-emitting state of at least one of the plurality of light sources based on information for controlling the plurality of light sources.

The camera 100 may acquire image information of the subject and may determine the shadow representation of the subject by analyzing the acquired image information. For example, the camera 100 may acquire data of an RGB format by converting an optical signal associated with the subject to an electrical signal based on the light intensity of each wavelength. The camera 100 may determine a light source to be emitted among the plurality of light sources by transforming the RGB data to data of a YUV format by an image transforming means (such as an image transforming apparatus, system, or method) and by using a luminance component detected from the YUV data. The light source determined by the camera 100 may emit light with predetermined intensity of light or provide information regarding the light source to be emitted to the user through the display unit 170.

The camera 100 may receive a user's command for controlling at least one of the plurality of light sources. A means for receiving the user's command may include a dial, one or more buttons, or a touch screen. Upon receiving the user's command, the camera 100 may determine the shadow representation of the subject displayed on the display unit 170 according to the user's command. The camera 100 may also control the plurality of light sources according to the user's command.

The camera 100 may provide a menu of the plurality of light sources to receive a user's command. The menu of the plurality of light sources may be provided by reflecting positions of the plurality of light sources in the light-emitting unit 110. In addition, the menu of the plurality of light sources may include a plurality of submenus. The plurality of submenus can correspond to the plurality of light sources, respectively. Each of the plurality of submenus may include a menu for controlling at least one selected from the group consisting of a light-emitting amount, a light-emitting time, a light-emitting color, and a light emission (on/off) of a corresponding light source.

The camera 100 may acquire information regarding an environment around the subject and determine the shadow representation of the subject according to the information regarding the environment. For example, the camera 100 may sense a luminance change around the subject by using a light intensity sensing sensor and convert the sensing signal to an electrical signal. The camera 100 may determine the shadow representation of the subject or control a light-emitting state of the plurality of light sources by using the acquired information regarding the environment. In addition, the camera 100 may control the plurality of light sources and adjust at least one selected from the group consisting of sensitivity of a film, an iris, and a shutter speed for an AE function of the camera 100 by using the acquired information. In addition, the camera 100 may control the plurality of light sources to emit the least light based on the surrounding brightness by using the acquired information when capturing is performed at night.

The camera 100 may change a direction of at least one of the plurality of light sources and may determine the shadow representation of the subject based on the change. In addition, the camera 100 may change a direction of the plurality of light sources based on the information regarding the plurality of light sources. In addition, the camera 100 may determine the shadow representation of the subject based on the change of the direction of a light source and may change a direction of the plurality of light sources as the shadow representation of the subject.

In operation 920, the camera 100 can display the shadow representation of the subject determined according to the information regarding the plurality of light sources on the display unit 170 thereof.

In operation 930, the camera 100 can control a light-emitting state of the plurality of light sources by using the shadow representation displayed on the display unit 170.

FIG. 10 is a flowchart of a method of displaying an image on the camera 100, according to an exemplary embodiment. Referring to FIG. 10, in operation 1010, the camera 100 can acquire information regarding a light-emitting state of at least one of a plurality of light sources. The information regarding the light-emitting state can be information regarding a state where the plurality of light sources emit light and may include, for example, at least one selected from the group consisting of a light-emitting amount, a light-emitting time, a light-emitting color, and a light emission (on/off) of the at least one of the plurality of light sources.

In operation 1020, the camera 100 can determine a shadow representation of a subject by using the information regarding the light-emitting state. The shadow representation can be a representation of a shadow, and the camera 100 may add or modify a shadow to or of at least one selected from the group consisting of the subject displayed on the display unit 170, a portion of the subject displayed on the display unit 170, and an object representing the subject displayed on the display unit 170.

In operation 1030, the camera 100 can display the shadow representation of the subject determined according to information regarding the plurality of light sources on the display unit thereof.

The methods described above may be implemented in a program instruction format executable through various computers and may be recorded on a computer-readable recording medium. The computer-readable recording medium may include program instructions, data files, or a data structure of a combination thereof. The program instructions recorded on the computer-readable recording medium may be particularly designed and configured for the invention or publicized to those of ordinary skill in the art associated with computer software. Examples of the computer-readable recording medium include magnetic media, such as a hard disk, a floppy disk, and a magnetic tape; optical media, such as a CD-ROM and a DVD; magneto-optical media, such as a floptical disk; and hardware devices, such as a ROM, a RAM, and a flash memory, particularly configured to store and execute program instructions. Examples of the program instructions are machine language codes generated by, for example, a compiler and high-level language codes executable by a computer by using, for example, an interpreter. The hardware devices may be configured to operate as at least one software module to perform an operation of the invention, or one or more software modules may be configured to operate at least one hardware device to perform an operation of the invention.

All references, including publications, patent applications, and patents, cited herein are hereby incorporated by reference to the same extent as if each reference were individually and specifically indicated to be incorporated by reference and were set forth in its entirety herein.

For the purposes of promoting an understanding of the principles of the invention, reference has been made to the embodiments illustrated in the drawings, and specific language has been used to describe these embodiments. However, no limitation of the scope of the invention is intended by this specific language, and the invention should be construed to encompass all embodiments that would normally occur to one of ordinary skill in the art. The terminology used herein is for the purpose of describing the particular embodiments and is not intended to be limiting of exemplary embodiments of the invention.

The apparatus described herein may comprise a processor, a memory for storing program data to be executed by the processor, a permanent storage such as a disk drive, a communications port for handling communications with external devices, and user interface devices, including a display, keys, etc. When software modules are involved, these software modules may be stored as program instructions or computer readable code executable by the processor on a non-transitory computer-readable media, random-access memory (RAM), read-only memory (ROM), CD-ROMs, DVDs, magnetic tapes, hard disks, floppy disks, and optical data storage devices. The computer readable recording media may also be distributed over network coupled computer systems so that the computer readable code is stored and executed in a distributed fashion. This media can be read by the computer, stored in the memory, and executed by the processor. The invention may be described in terms of functional block components and various processing steps. Such functional blocks may be realized by any number of hardware and/or software components configured to perform the specified functions. For example, the invention may employ various integrated circuit components, e.g., memory elements, processing elements, logic elements, look-up tables, and the like, which may carry out a variety of functions under the control of one or more microprocessors or other control devices. Similarly, where the elements of the invention are implemented using software programming or software elements, the invention may be implemented with any programming or scripting language such as C, C++, Java, assembler, or the like, with the various algorithms being implemented with any combination of data structures, objects, processes, routines or other programming elements. Functional aspects may be implemented in algorithms that execute on one or more processors. Also, using the disclosure herein, programmers of ordinary skill in the art to which the invention pertains can easily implement functional programs, codes, and code segments for making and using the invention. Furthermore, the invention may employ any number of conventional techniques for electronics configuration, signal processing and/or control, data processing and the like. Finally, the steps of all methods described herein can be performed in any suitable order unless otherwise indicated herein or otherwise clearly contradicted by context.

For the sake of brevity, conventional electronics, control systems, software development and other functional aspects of the systems (and components of the individual operating components of the systems) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections may be present in a practical device.

The words “mechanism” and “element” are used broadly and are not limited to mechanical or physical embodiments, but may include software routines in conjunction with processors, etc. The use of any and all examples, or exemplary language (e.g., “such as”) provided herein, is intended merely to better illuminate the invention and does not pose a limitation on the scope of the invention unless otherwise claimed. No item or component is essential to the practice of the invention unless the element is specifically described as “essential” or “critical”. It will also be recognized that the terms “comprises,” “comprising,” “includes,” “including,” “has,” and “having,” as used herein, are specifically intended to be read as open-ended terms of art. The use of the terms “a” and “an” and “the” and similar referents in the context of describing the invention (especially in the context of the following claims) are to be construed to cover both the singular and the plural, unless the context clearly indicates otherwise. In addition, it should be understood that although the terms “first,” “second,” etc. may be used herein to describe various elements, these elements should not be limited by these terms, which are only used to distinguish one element from another. Furthermore, recitation of ranges of values herein are merely intended to serve as a shorthand method of referring individually to each separate value falling within the range, unless otherwise indicated herein, and each separate value is incorporated into the specification as if it were individually recited herein.

While this invention has been particularly shown and described with reference to embodiments and drawings thereof, the invention is not limited thereto. Numerous modifications, adaptations, or changes in form and details will be readily apparent to those of ordinary skill in this art without departing from the spirit and scope of the present invention as defined by the following claims. Therefore, the scope of the invention is defined not by the detailed description of the invention but by the following claims, and all differences within the scope will be construed as being included in the invention.

What is claimed is:

1. A camera comprising:
a plurality of light sources that illuminate a subject;
a lens unit that receives image information of the subject;
a controller that determines a shadow representation of the subject according to information regarding the plurality of light sources; and
a display unit that displays the determined shadow representation.

2. The camera of claim 1, wherein the controller controls a light-emitting state of the plurality of light sources by using the shadow representation displayed on the display unit.

3. The camera of claim 1, wherein the controller adds or modifies a shadow to or of at least one selected from the group consisting of the subject displayed on the display unit, a portion of the subject displayed on the display unit, and an object representing the subject displayed on the display unit.

4. The camera of claim 1, further comprising a storage unit that stores at least one object associated with a plurality of shadow representations,
wherein the controller determines the at least one object as the shadow representation of the subject based on the information regarding the plurality of light sources.

5. The camera of claim 1, further comprising a driver that changes a direction of at least one of the plurality of light sources,
wherein the controller determines the shadow representation of the subject based on the change.

6. The camera of claim 1, further comprising an input unit that receives a user's command for controlling at least one of the plurality of light sources,
wherein the controller determines the shadow representation of the subject according to the user's command, and the information regarding the plurality of light sources comprises the user's command.

7. The camera of claim 6, wherein the display unit displays a menu for receiving the user's command for each of the plurality of light sources.

8. The camera of claim 7, wherein the menu comprises a plurality of submenus, each of the plurality of submenus corresponds to a respective one of the plurality of light sources, and the plurality of submenus are displayed on the display unit in positions corresponding to the respective one of the plurality of light sources.

9. The camera of claim 1, wherein the information regarding the plurality of light sources comprises information regarding a light-emitting state of at least one of the plurality of light sources, and
the controller acquires the information regarding the light-emitting state of the at least one of the plurality of light sources and determines the shadow representation of the subject by using the information regarding the light-emitting state.

10. The camera of claim 9, wherein the information regarding the light-emitting state of the at least one of the plurality of light sources comprises information regarding at least one selected from the group consisting of a light-emitting amount, a light-emitting time, a light-emitting color, and a light emission of the at least one of the plurality of light sources.

11. The camera of claim 1, further comprising a sensor unit that acquires information regarding an environment around the subject,
wherein the controller determines the shadow representation of the subject according to the information regarding the environment, and the information regarding the plurality of light sources comprises the information regarding the environment.

12. The camera of claim 1, wherein the controller determines the shadow representation of the subject by analyzing image information of the subject, and
the information regarding the plurality of light sources comprises information obtained by analyzing the image information.

13. A light-emitting apparatus comprising:
a plurality of light sources;
a circuit substrate equipped with the plurality of light sources; and
a holder disposed on one surface of the circuit substrate and fixes the circuit substrate to the light-emitting apparatus.

14. The light-emitting apparatus of claim 13, further comprising a light-concentrating lens disposed on the holder.

15. The light-emitting apparatus of claim 13, wherein the holder comprises a plurality of reflecting mirrors, and
each of the plurality of reflecting mirrors is disposed on one of the plurality of light sources.

16. A method of displaying an image on a camera, the method comprising:
determining a shadow representation of a subject according to information regarding a plurality of light sources that illuminate the subject; and
displaying the determined shadow representation.

17. The method of claim 16, wherein the information regarding the plurality of light sources comprises information regarding a light-emitting state of at least one of the plurality of light sources, and
the determining of the shadow representation comprises:
acquiring the information regarding the light-emitting state of the at least one of the plurality of light sources; and
determining the shadow representation of the subject by using the information regarding the light-emitting state.

18. The method of claim 16, further comprising receiving a user's command for controlling at least one of the plurality of light sources,
wherein the information regarding the plurality of light sources comprises the user's command.

19. The method of claim 18, further comprising displaying a menu for receiving the user's command for each of the plurality of light sources.

20. A method of displaying an image on a camera, the method comprising:
acquiring information regarding a light-emitting state of at least one of a plurality of light sources;
determining a shadow representation of a subject by using the information regarding the light-emitting state; and
displaying the determined shadow representation.
